(19) United States
(12) Patent Application Publication
(10) Pub. No.: US 2024/0336077 A1
(43) Pub. Date: Oct. 10, 2024

(54) METHOD FOR MANUFACTURING A DECOR SHEET FOR DECORATIVE PANEL

(71) Applicant: Unilin, BV, Wielsbeke (BE)

(72) Inventors: Bastien GRILLET, Wielsbeke (BE); Christophe MAESEN, Lichtervelde (BE); Benjamin CLEMENT, Waregem (BE)

(73) Assignee: Unilin, BV, Wielsbeke (BE)

(21) Appl. No.: 18/292,901

(22) PCT Filed: Jul. 19, 2022
(86) PCT No.: PCT/IB2022/056613

§ 371 Date: Jan. 27, 2024

(30) Foreign Application Priority Data
Jul. 28, 2021 (EP) 21188281.6

(51) Int. Cl. B41M 3/06; B41M 5/00

(52) U.S. Cl. CPC B41M 3/06; B41M 5/0005

(57) ABSTRACT

A method is provided for manufacturing a printed décor sheet. The method may involve providing a first printable or printed substrate. At least one predetermined operation may be performed on the substrate, wherein the predetermined operation causes the deformation of the substrate in at least one direction. The deformation may be measured to obtain at least one deformation parameter. A first master image may be provided. An image processing operation may be performed on the first master image to obtain a second master image. The second master image may be printed on a second printable substrate to obtain the décor sheet. The image processing operation may involve at least modifying the first master image on the basis of the at least one deformation parameter.

This application claims priority under 35 USC § 119 (a)-(d) from EP patent application Ser. No. 21/188,281.6, which was filed on Jul. 28, 2021, the entire content of which is incorporated herein by reference.

### BACKGROUND

### 1. Field

The present invention relates a method for manufacturing a décor layer or sheet of the type used in panels having a decorative surface, or so-called decorative panels. The invention also relates to a method for manufacturing such panels.

More particularly the invention is related to a method for manufacturing décor layers that are thermally laminated on top of a substrate for forming said panels. The panels can comprise a polymeric based substrate, preferably thermoplastic based substrate, such as PVC (Polyvinyl chloride), PP (Polypropylene), LVT (Luxury Vinyl Tile), SPC (Solid Polymer Composite) or WPC (Wood polymer composite) based substrate. The invention can further relate to mineral-based board of cement-based board, like for example, fiber cement based board or magnesium oxide based board.

### 2. Related Art

Traditionally, the decor or pattern of such panels is printed on thermoplastic sheet by means of offset or rotogravure printing. The obtained sheet is taken up as a decorative sheet in a decorative panel. For manufacturing the decorative panels thermal lamination or gluing can be practiced. According to the thermal lamination process the already printed sheet is fixed with action of heat and pressure on top of a substrate. Alternatively, the decorative sheet can be thermal laminated to a surface of a transparent or translucent thermoplastic protective layer. In this latter case, after thermal lamination, a stack is formed comprising at least a plate shaped substrate, said decorative sheet and the layer. Said stack can result in a mutual connection or adherence of the layers after thermal lamination or gluing of the decorative sheet with on top of the plate shaped substrate. As a result, a decorative panel is obtained. It is possible to provide a relief in the surface of the panel, for example in the protective layer, during the same thermal lamination operation, namely by bringing said protective layer in contact with a structured press element, for example a structured roller. Preferably, said relief can be in register with the pattern on the decorative layer.

The printing of the sheet by means of an analog printing process, such as by rotogravure or offset printing, at affordable prices inevitably leads to large minimal order quantities of a particular decorative sheet and restricts the attainable flexibility. A change of decor or pattern necessitates a standstill of the printing equipment of about 8 hours. This standstill time is needed for exchange of the printing rollers, the cleaning of the printing equipment and for adjusting the colors of the new decor or pattern to be printed.

Instead of analog printing techniques, digital printing techniques, especially inkjet printing techniques, are becoming increasingly popular for the creation of decors or patterns. Such digital techniques can enhance the flexibility in the printing of decors significantly. Reference is amongst others made to the U.S. Pat. Nos. 9,885,188, 11,059,320 and the WO 2020/161569, where such techniques are disclosed.

During private research, the inventor has also encountered problems with subsequent thermal lamination of printed sheets. In particular, the inventor has encountered problems with expansion and deformation of the printed sheet during said thermal lamination. The inventor has noticed that heating and pressing cause deformation of the printed sheet and of the printed pattern thereof thereby complicating the pressing in register of the relief.

### SUMMARY

The present invention aims in the first place at an alternative method for manufacturing decorative sheets that, in accordance with several of its preferred embodiments, is directed to solve one or more of the problems arising in the state of the art.

Therefore the present invention, in accordance with its first independent aspect, relates to a method for manufacturing a printed décor sheet comprising the steps of: providing a first printable or printed substrate; performing at least one predetermined operation on said substrate, wherein said predetermined operation causes the deformation of the substrate in at least one direction; measuring said deformation to obtain at least one deformation parameter; providing a first master image; performing an image processing operation on said first master image to obtain a second master image; printing said second master image on a second printable substrate to obtain the décor sheet. In accordance with the first aspect of the invention said image processing operation involves at least modifying the first master image on the basis of said first deformation parameter. In this way it is possible to predict what will be the deformation and compensate said deformation in the pattern through the image processing operation that is based on said predicted deformation. Said image processing operation involves modifying the first master image on the basis of at least a modification parameter that is function of said first deformation parameter. For example, said at least first deformation parameter can be a scale parameter and said image processing operation may involve enlarging or reducing the dimension of said first master image on the basis of said at least first deformation parameter. Preferably, said image processing operation may involve deforming said first master image of a deformation that is opposite to the measured deformation. In this way, for example, it is possible to compensate a predicted expansion caused by said predetermined operation by contracting the first master image for obtaining the second master image. Because of the predetermined operation, the printed second master image will expand as predicted so that the dimensions of the original first master image are restored. Preferably the image processing operation can involve a preliminary operation of calculating one or more modification parameter on the basis of said deformation parameter. Subsequently, the image processing operation may involve applying the modification parameter to the first master image in order to obtain the second master image.

Said deformations can comprise linear and non-linear expansion along the length and/or width direction of the first printable or printed substrate, bowing of the first substrate and/or parallelogram deformation, i.e. differentiated linear expansion along the length and/or width direction of the first printable or printed substrate.

According to the invention multiple deformation parameter can be measured. For example, deformation in multiple different direction can be measured. It is also possible to measure multiple deformation parameters in a same direction. For example, said deformation parameters in a same direction can be measured in multiple points of the first substrate. In this way a more accurate image processing operation can be performed based on multiple parameters or on one or more deformation parameter calculated on the basis of said parameters.

In the most preferred embodiment, the method comprises the step of identifying a plurality of sectors on the surface of said first printable or printed substrate and measuring said deformation to obtain at least one deformation parameter for each of said sectors. In fact, the inventor has observed that the predetermined operation can have different effect in different portions of the substrate, therefore by identifying said sectors and by measuring the deformation parameters in each sector it is possible to obtain a more realistic and precise estimate of the deformation. In the preferred embodiment, said sectors are configured to divide the substrate in a grid or raster manner. Preferably said sectors may show all the same dimension and/or shape, in this way it may be possible to optimize the distribution of said sectors on the first printable or printed substrate.

Each of said sectors on the first substrate can correspond to a respective area of the first master image so that said image processing operation may involve modifying each area of the first master image on the basis of said first deformation parameter measured in the respective sector. For example, each area can be modified on the basis of a respective modification parameter, for example that has been previously calculated on the basis of a respective deformation parameter.

The deformation parameters are stored in a memory device connected to a processing unit, for example a personal computer. This processing device may further be configured for performing the image processing operation on the first master image, thereby providing as an output, of this image processing operation, the second master image.

Said deformation can be measured with one or more measuring devices. Said measuring devices can comprise optical sensor, haptic sensor, mechanical sensor and/or electromagnetic sensor. Said sensor can be connected, even wireless, with the processing unit and/or directly with the memory.

The first substrate can comprise or be provided with a predetermined amount of ink before being subjected to said predetermined operation. In particular the method can comprise the step of providing a printed first substrate, i.e. a first substrate that has been previously provided with a predetermined amount of ink, for example by taking said printed first substrate from a stock. Alternatively, the method may comprise the step of providing a blank first substrate with a predetermined amount of at least one ink, for example a step of printing, preferably inkjet printing, said ink onto said substrate. Said predetermined amount of ink can be preferably uniformly distributed onto said first substrate. Said ink can be a pigment containing ink and said substrate can comprise or be provided with a pigment dry weight comprised between 0.1 g/sqm and 15 g/sqm.

In the preferred embodiment said predetermined amount of ink on the first substrate is selected on the basis of the first and/or the second master image to be printed. In fact, it may be possible to estimate the amount of ink that has to be printed onto a substrate for reproducing said first and/or second master image, and the predetermined amount of ink on said first substrate can be selected on the basis of said estimated value. For example, the predetermined amount of ink on said first substrate can differ from the estimated value, of the amount of ink for printing the first and/or second master image, of less than the 50%, preferably less than 30% of said estimated value. For example, in the preferred embodiment it is possible that a stock of printed first substrates comprises multiple printed first substrate each comprising a respective predetermined amount of ink, the method then requires selecting the printed first substrate from the stock that has the predetermined amount of ink that is closer, possibly substantially equal, to the predetermined amount.

In the method of the invention, water-based inks, solvent-based ink, oil-based inks or UV curing inks or hydro-UV inks can be used. In particular it is preferable that said inks are UV curing inks or hydro-UV inks since their use doesn't necessarily require the previous application of a primer on the substrate, although in some embodiments water-based inks can be preferred because their lower cost and good adhesion in particular with vinylic materials. Preferably said ink provided on the first substrate, covers the majority, and preferably 25 percent or more, even more preferably 50% or more of the surface of first substrate. It is particularly preferred that the ink is a pigmented ink.

Said predetermined amount of ink can be provided on the first substrate according to a pattern. Said pattern can be any kind of drawing, albeit it is preferable that the pattern is close to the first master image. For example, in case the first master image is a wood imitating image, the pattern on the first substrate can be a wood imitating image. In this way the pattern on the first substrate can replicate an ink distribution on the first substrate that is as close as possible to the ink distribution for printing the first master image, while at the same time the first substrate with the pattern can be selected from a stock without the necessity to print the pattern before performing the predetermined operation. With the aim of improving the accuracy of the measurement of said deformation, according to the preferred embodiment said pattern can coincide with the first master image.

It is also possible that the first substrate is printed with multiple patterns, preferably wherein each of said pattern is characterized by a respective predetermined amount of ink. In this way it may be possible to determine the deformation parameter for each different pattern and subsequently modify the first master image, for obtaining the second master image, on the basis of the deformation parameter corresponding to the ink amount that is closer or equal to the ink amount that is needed for printing the second master image, and/or it is possible to determine the ink amount for printing the second master image on the basis of the ink amount of the first substrate that causes a specific deformation, for example the minor deformation.

In some embodiments the first substrate can comprise or be provided with an ink receiver layer and/or with an adhesion promoter layer before being subjected to said predetermined operation. In case the first substrate is a pre-printed first substrate it preferably comprises the ink receiver layer and/or the adhesion promoter layer. Alternatively, in case the method comprises the step of providing the first substrate with the ink, the first substrate can be provided with the ink receiver layer or being previously provided with said ink receiver layer.

Ink receiver layer are preferably used in case of water-based inks. Said ink receiver layer can comprise water-based substances and/or a binder.

The addition of silica, or as an alternative aluminum or other water absorbing materials, to the ink receiving layer improves the fixation of the ink droplet, in particular the fixation of the pigments when, as is preferred, used is made of pigment containing inks. Increasing the water retaining capabilities is especially important when the aforesaid digital printing operation is a single pass printing operation, i.e. a printing operation wherein the entire printed pattern is formed in one relative movement of the carrier layer with respect to the printing equipment.

Preferably, a binding agent is applied in the ink receiving layer, which is chosen from the list consisting of polyurethane based binder (PU), an acrylic polyurethane binder, a polyacrylic binder, a polyether, polyvinylalcohol, a vinyl ester, thiol, carbodi-imide, polyvinylbutyrate, vinyl chloride-vinyl acetate copolymer (VC-VA), acrylic polymer and an aliphatic urethane acrylic binder. According to the most preferred embodiments the binding agent is chosen from the list consisting of polyurethane based binder, acrylic polyurethane, vinyl chloride-vinyl acetate copolymer and aliphatic urethane acrylic binder.

Preferably, said binding agent is a high molecular weight water soluble polymer, preferably having a molecular weight above 40000 as defined by Size Exclusion Chromotography (SEC) using tetrahydrofuran (THF) as a solvent and calibrated using a polystyrene standard. The molecular weight of the binding agent may be anywhere between 40000 and 180000.

Preferably said ink receiving layer comprises pigments and binder with a pigment to binder ratio of 0.85 or more. A pigment to binder ratio of 1 and higher, 1.5 and higher, 2 and higher is not excluded. This preferred amount of pigments in the ink receiving layer provides for a water retention capability which is sufficient for high speed single pass printing, e.g. at 40 meter per minute or more.

According to the most preferred embodiment said inkjet receiver layer is present on the first substrate in the form of a unique layer. Anyway, it is not excluded that said inkjet receiver coating is in the form of two layers, wherein respectively a first layer with a first composition and a second layer with a second composition wherein said first and second composition may be either the same or different compositions.

The adhesion promoter layer, can be used preferably in case of using UV curable inks. It is noted that the adhesion promoter layer can be applied either below or above the printed pattern. The adhesion promoter layer comprises at least an adhesion promoter agent. In alternative embodiments said adhesion promoter agents, instead of being applied in a separate adhesion promoter layer, can be mixed in the ink. As adhesion promoter agent, preferably VC-VAC (Vinyl chloride-vinyl acetate) copolymer is used. In this case, this can be provided on the digital print. Possibly, such a adhesion promoter agent can be used which also has a hydroxy or carboxy functionality. In general, in respect to VC-VAC it can be noted that this agent is also applied as a binding agent in inks for digital printing, for example, in UV-based or solvent-based inks.

The first substrate is made of a polymeric material. In the most preferred embodiment, the first substrate is preferably in form of a thermoplastic foil, for example made of polyvinylchloride (PVC), polyethylene (PE) or polypropylene (PP) or PET. In this case the first substrate can comprise a thickness ranging between 40 micron and 200 micron.

The predetermined operation can be any operation that is able to cause a deformation of the first substrate. Preferably the predetermined operation can be selected from the group comprising: heating, pressing, stretching, lamination or a combination thereof.

said predetermined operation can preferably involve a thermal lamination of said thermoplastic foil with a second thermoplastic foil, for example a transparent thermoplastic foil. Alternatively, the predetermined operation can preferably involve a thermal lamination of said thermoplastic foil on a substrate, for example a flexible or rigid substrate. Said substrate can be made of a polymeric material, a wood-based material or mineral based material.

Thermal lamination can be conducted at a temperature above 80° C., preferably above 100° C.

After the second master image is obtained, via the image processing operation, it can be printed on a second support for obtaining a printed layer. The second substrate can be made similarly to the first support, preferably it can be the same of the first substrate. Preferably the second substrate is made of the same material of the first substrate, for example made of a polymeric material. It is also preferable that the second substrate comprises one or more features in common with the first substrate, said feature can preferably belong to the group comprising: weight, thickness, ash content, plasticizer content, Glass transition temperature. Within the context of the invention with feature in “common” it is meant the feature, in particular the value thereof, are substantially the same in the first substrate and in the second substrate, and that the value of said features can be slightly different each other, preferably they can differ for less of the 10%, preferably less of the 5%. The inventor has found that more the first and second substrate are similar each other, the higher is the accuracy with which the deformation can be compensated. A difference, between the feature of the second and of the first substrate, that stays below the above-mentioned limit may allow a high accuracy in the compensation of the deformation by using standard first substrate collected in a stock.

Advantageously the second substrate can be provided with an ink receiver layer and/or an adhesion promoter layer. Said ink receiver layer and/or an adhesion promoter layer of the second substrate can be made similarly to the ink receiver layer and/or an adhesion promoter layer of the first support. Preferably the ink receiver layer and/or an adhesion promoter layer of the second substrate may comprise the same components than that of the first substrate, for example may comprise the same composition.

Said second master image is preferably printed on the second substrate via digital printing, preferably inkjet printing. Both single pass and multi pass printing are possible, albeit single pass printing provides for a higher productivity. Said printing operation can be performed with water-based inks, solvent-based ink, oil-based inks or UV curing inks or hydro-UV inks can be used. Preferably the ink is a pigmented ink. According to the preferred embodiment the ink used for printing on the second substrate are similar, preferably, the same provided on the first substrate.

In the preferred embodiment, the obtained printed layer can be used as decorative layer in decorative panels, for example floor, wall, ceiling or furniture panel. The said decorative panels may be of the type comprising a support layer and a top layer, the top layer comprising the decorative layer. According to alternative embodiments, the printed layer can be use for decorative surfaces in general, for example wallpaper.

The support layer can be made of a polymeric material, preferably a thermoplastic material, for example made of polyvinylchloride (PVC), polyethylene (PE) or polypropylene (PP), PET. It is also possible that the support layer is comprises a mineral-based or a cement-based board, for example an MgO-based or a Portland cement board. Said mineral-based or cement-based board can comprise fiber, for example glass or cellulose fibers.

In the preferred embodiment wherein the panel is a floor panel, the method may comprise the step of providing said support layer with coupling elements for mechanical coupling to another floor panel. Said step of providing the support layer with coupling element is preferably performed after that the decorative layer has been provided on the support layer. It is noted that said support layer can also be in form of large board that are cut into multiple laminate panel.

The method of the invention can comprise the step of providing said top layer, including at least said decorative layer, onto said support layer. In particular, the decorative layer can be pressed, heat laminated or glued on top of the support layer. in the most preferred embodiment, the decorative layer is preferably thermal laminated on top of the support layer. Said thermal lamination can be performed substantially in the same way as per the above mentioned predetermined operation.

The top layer can further comprise a protective layer, preferably a transparent layer and possibly comprising hard particles. Said wear layer can comprise a thermoplastic sheet for example made of PVC. The protective layer can be thermal laminated on top of the decorative layer. The thermal lamination of the protective layer on the decorative layer can happen before, during and or after the decorative layer has been provided on the support layer. In a first preferred embodiment, the protective layer is thermal laminated on top of the decorative layer in the same step of thermal lamination of the decorative layer itself on top of the support layer. In a second preferred embodiment, the protective layer is thermal laminated on top of the decorative layer to form the top layer and subsequently the top layer is either thermal laminated or glued on top of the support layer.

The method of the invention may comprise the step of forming a relief on the surface of said panel. Said relief is preferably formed at least in said top layer. In the most preferred embodiment the relief is in register with the printed décor provided on the printed layer, i.e. the relief has structural feature corresponding to structural features of the printed décor. For example, in case of a printed décor representing a wood imitation the relief has an excavation shaped to imitate a wood pore where the printed décor shows a wood pore. Thanks to the inventive solution proposed herein, it is possible to improve the alignment between the printed décor and the relief since any deformation of the printed décor that can occur before and/or during the alignment of the printed décor with the relief is taken into account.

The relief can be embossed in the top layer during the thermal lamination step of the protective layer onto the decorative layer using an embossment plate or roller. The relief can also be obtained before or after that the top layer is provided on the support layer.

### BRIEF DESCRIPTION OF THE DRAWINGS

With the intention of better showing the characteristics according to the invention, in the following, as an example without limitative character, an embodiment is described, with reference to the accompanying drawings, wherein:

FIGS. 1a to 1e schematically show some step in an image processing operation according to the method of the invention;

FIG. 2 shows a printed substrate;

FIG. 3 shows some steps in a method in accordance with the first aspect of the invention;

FIG. 4 shows some steps in a method in accordance with the first aspect of the invention;

FIG. 5 shows in perspective a panel obtained by means of the method of FIG. 6;

FIG. 6 shows some steps of a method for manufacturing a panel in accordance with a second aspect of the invention.

### DESCRIPTION OF NON-LIMITING EMBODIMENTS

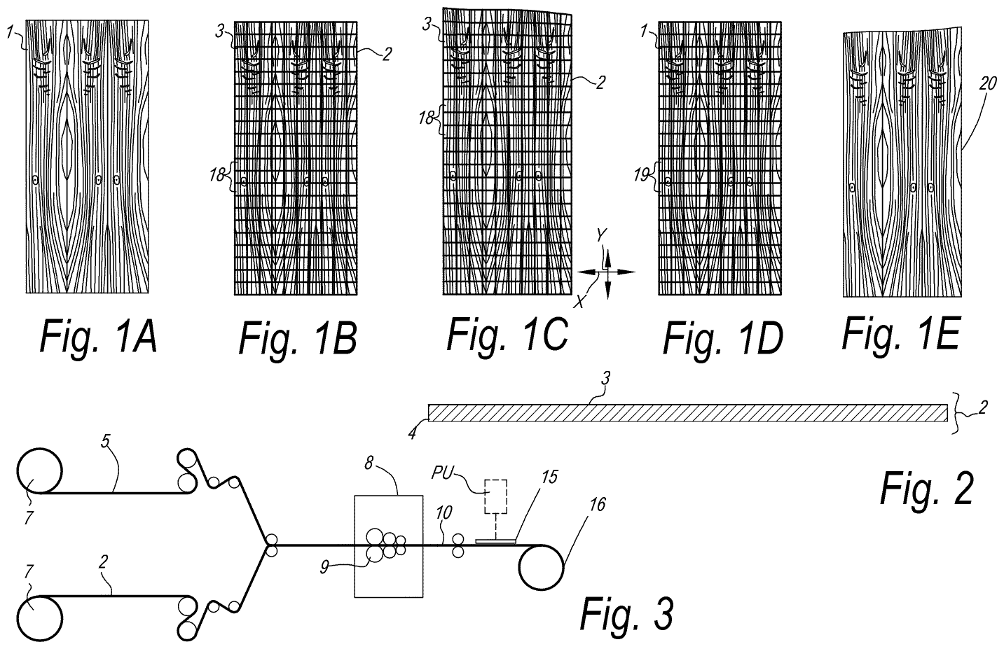

FIG. 1 schematically illustrates a first master image 1, in this case representing a wood décor. In the method according to the invention, the first master image 1 is printed on a first substrate 2, illustrated in FIG. 2, for forming a first printed décor 3.

In this example the first substrate 2 comprises a PVC sheet 4 having a thickness ranging between 40 micron and 200 micron.

The first master image 1 is printed on the first substrate 2 by inkjet printing so to provide on said first substrate an amount of ink between 0.01 gsm and 5 gsm dry weight. Ink is preferably UV curable pigment containing ink.

After printing, the first substrate 2 is subjected to a predetermined operation shown in FIG. 3. In the example, the predetermined operation involves thermal lamination of a transparent protective layer 5 onto the first substrate 2. The protective layer 5 is made of PVC. In particular, the first substrate 2 and the protective layer 5 are taken from a separate and respective starting roll 7 and transported to a lamination station 8 where one or more lamination rollers 9 apply pressure and heat to the first substrate 2 and the protective layer 5 in order to attach them together thereby obtaining laminated sheet 10. The obtained laminated sheet 10 is, for example, subsequently rolled on a second roller 16 or cut into sheets.

The predetermined operation illustrated in FIG. 3 causes a deformation of the first substrate as illustrated in FIG. 1c. In the example, said deformation comprises an expansion of the first substrate 1 in both a longitudinal Y and a transversal X direction of the first substrate. The example it is also shows that the expansion in the longitudinal direction Y may vary along the transverse direction X.

Coming back to FIG. 3, after the predetermined operation, in the example after drying, the first substrate 2 is subjected to a measuring step for measuring the deformation and determine at least a deformation parameter DP. Preferably to determine said deformation parameter DP multiple measurement can be performed, by respective measuring devices 15, in particular before and after said predetermined operation, so that the deformation parameter is defined by the difference between said measured values.

As shown in FIGS. 1b and 1c a plurality of sectors 18 are identified on the surface of said first substrate 1, in particular in said first printed décor 3. Said sectors 18 can be physically identified by printing separating lines on the substrate or by leaving blank areas on the surface of the first substrate 2. Alternatively, the sectors 18 can be only virtually identified. The method involves the step of determining at least one deformation parameter DP for each sector 18.

In the example, the sectors 18 are disposed in a raster manner on a predetermined number of columns 1, 2, . . . i and on a predetermined number of rows 1, 2, . . . j. For each sector 18 is determined the deformation parameter DP_{i,j}.

The deformation parameters DP_{i,j} are stored in memory of a processing unit PU (shown in FIG. 3), for example a personal computer. Said processing unit PU performs an image processing operation on the first master image 1 that in the example involves identifying multiple areas 19 of said first master image 1 (FIG. 1D), each of them corresponding to a respective sector 1 on the first substrate 2 and involves modifying each area of the first master image 1 on the basis of the respective deformation parameter DP_{i,j}. In the example each area is modified on the basis of a respective modification parameter MP_{i,j} that is calculated by the processing unit PU. In the example, the modification parameter MP_{i,j} for each area is the opposite of the respective deformation parameter DP_{i,j}: MP_{i,j}=−DP_{i,j}.

As a result of said image processing operation a second master image 20 is obtained which is a deformed version of the first master image 1 as shown in FIG. 1e. In particular, with relation to example given, the second master image 20 is smaller than the first master image 1.

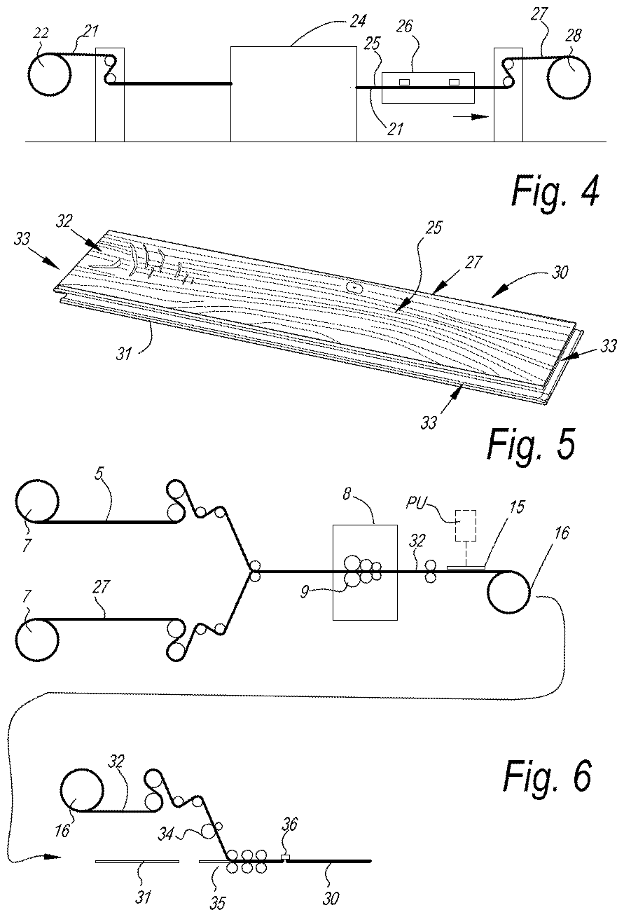

The method then continues as described in FIG. 4. FIG. 4 illustrates that a second substrate 21, for example in form of a printable PVC sheet 4 may be un-winded from a starting roller 22 and to an inkjet printer 24. The printer 24, in this example, relates to a printer of the single pass type. The inkjet printer 24 is commanded for printing the second master image 20 on the second substrate 21 thereby forming a second printed décor 25 on said second substrate 21. The printed second substrate 21 is optionally subjected to UV curing into a curing station 26 to finally obtain a printed layer 27 that is subsequently wound up in a second roller 28.

It is noted that the features of the PVC sheet 4, of the ink and of the printing parameters are substantially the same as those involved in the manufacturing of the first printed substrate.

The obtained printed layer 27 can be used as a decorative layer 27 in a decorative panel 30 as illustrated in FIG. 5. The obtained decorative panels 30 at least comprise a substrate layer 31, for example made of PVC, preferably SPC, and a top layer 32. The top layer 32 comprises the decorative layer formed by the printed layer 27 and the protective layer 5. In the example the decorative panel 30 is a floor panel comprising coupling means 33 on the long and short edges for coupling with adjacent floor panels in a floor covering. As illustrated in FIG. 5 such coupling means or coupling parts 33 can basically have the shape of a tongue and a groove.

To this aim the printed layer 27 is used in laminate panel manufacturing process, some steps of which are illustrated in FIG. 6. In particular, FIG. 6 shows that the printed layer 27 is subjected to the above-mentioned predetermined operation, in the example thermal laminated below the protective sheet 5 to obtain the laminated top layer 32. Said thermal lamination is preferably conducted in the same way as for the first substrate 2 and as described in FIG. 3.

As a result of the said thermal lamination the printed layer 27 and the printed décor thereof will deform substantially as predicted with the first printed substrate so to recover the shape and dimension of the first master image 1.

Preferably, at least one of the lamination rollers 9 is a structured roller having a structure relief that provides a relief at least in the protective layer 5 during the same thermal lamination. Thanks to the fact that the deformation that occur during the predetermined operation is compensated by the method according to the invention, the relief can be made formed in register with the printed décor with a increased precision thereby leading to an higher quality of the panel.

FIG. 6 further illustrates that the top layer 32 is glued on top of the substrate layer 31 to form the panel 30. A coating roller 34 provide a glue on the underside of the top layer 32 and subsequently the top layer 32 is pressed on the substrate layer 31 with rollers 35. A cutter 36 cuts at least the top layer 32 in order to obtain the panel 30. In an alternative embodiment the top layer 32 or the sole printed layer 27 can be thermal laminated on top of the substrate layer 31.

The present invention is in no way limited to the above described embodiments, but such methods, paper layers, panel may be realized according to several variants without leaving the scope of the invention.

The invention is further disclosed by the following item list as defined by the below numbered items.
1. A method for manufacturing a printed decorative layer (27) comprising the steps of:
   providing a first printable or printed substrate (2) wherein said first printable or printed substrate (2) comprises a thermoplastic layer (4);
   performing at least one predetermined operation on said first substrate (2), wherein said predetermined operation causes the deformation of the first substrate (2) in at least one direction (X, Y);
   measuring said deformation to obtain at least one deformation parameter (DP);
   providing a first master image (1);
   performing an image processing operation on said first master image to obtain a second master image (20);
   printing said second master image (20) on a second printable substrate (21) to obtain the décor sheet (27);
characterized in that said image processing operation involves at least modifying the first master image (1) on the basis of said first deformation parameter (DP).
2. —Method according to item 1, wherein said at least first deformation parameter (DP) is a scale parameter, and in that said image processing operation involves enlarging or reducing one or more dimensions of said first master image (1) on the basis of said least first deformation parameter (DP).
3. —Method according to item 1 or 2, wherein said image processing operation involves deforming said first master image (1) of a deformation that is opposite to the measured deformation.
4. —Method according to any of the preceding items, wherein said image processing operation involves modifying the first master image (1) on the basis of at least a modification parameter (MP) that is function of said first deformation parameter (DP).
5. —Method according to any of the preceding items, wherein said image processing operation involves dividing said first master image (1) into at least two areas (19) and involves modifying at least one of said areas.
6. —Method according to item 5, wherein said image processing operation involves modifying each area (19) on the basis of a different modification parameter (MP).
7. —Method according to any of the preceding items, wherein it comprises printing at least a pattern on said first printable substrate (2), preferably said pattern corresponding to the first master image (1).
8. —Method according to any of the preceding items, wherein it comprises printing a plurality of patterns on respective portions of said first printable substrate (2).
9. —Method according to item 8, wherein each pattern of said plurality is printed with a respective predetermined ink amount.

10. —Method according to any of the preceding items, wherein said pattern differs from said first master image (1).
11. —Method according to any of the preceding items, wherein it comprises identifying a plurality of sectors (18) on the surface of said first printable or printed substrate (2) and measuring said deformation to obtain at least one deformation parameter (DP_{i,j}) for each of said sectors (18).
12. —Method according to any of the preceding items, wherein said predetermined operation is selected between the group comprising: heating, pressing and/or laminating.
13. —Method according to any of the preceding items, wherein said printing operation is performed via inkjet printing.
14. —Method according to any of the preceding items, wherein said printing operation is performed via UV curable inks, water-based inks or hydro-UV curable inks.
15. —Method according to any of the preceding items, wherein said first printable or printed substrate (1) comprises an ink receiver layer and/or an adhesion promoter layer.
16. —Method according to any of the preceding items, wherein the second substrate (21) is the same of the first substrate (1).

17. —Method according to any of the preceding items, wherein the second substrate (21) comprises one or more features in common with the first substrate (2), preferably said feature in common belong to the group comprising: material, weight, thickness, ash content, plasticizer content and glass transition temperature.
18. —Method for manufacturing a panel, preferably a floor, wall, furniture or ceiling panel, comprising the steps of:
   providing a substrate (31), preferably wood based substrate;
   attaching a decorative layer (27) obtained in the method according to any of the preceding items on said substrate (31).
19. —The method according to item 18, wherein said decorative layer (27) is subject to said predetermined operation.
20. —Decorative layer (27) for decorative panel obtained in the method according to any of the items from 1 to 17.

1. A method for manufacturing a printed decorative layer the method comprising:
providing a first printable or printed substrate wherein the first printable or printed substrate includes a thermoplastic layer;
performing at least one predetermined operation on the first substrate, wherein the predetermined operation causes a deformation of the first substrate in at least one direction;
measuring the deformation to obtain at least one deformation parameter;
providing a first master image;
performing an image processing operation on the first master image to obtain a second master image;
printing the second master image on a second printable substrate to obtain the decorative layer;
wherein the image processing operation involves at least modifying the first master image on the basis of the at least one deformation parameter.

2. The method according to claim 1, wherein the at least one deformation parameter is a scale parameter; and
wherein the image processing operation involves enlarging or reducing one or more dimensions of the first master image on the basis of the at least one deformation parameter.

3. The method according to claim 1, wherein the image processing operation involves deforming the first master image of a deformation that is opposite to the measured deformation.

4. The method according to claim 1, wherein the image processing operation involves modifying the first master image on the basis of at least one modification parameter that is function of the at least one deformation parameter.

5. The method according to claim 1, wherein the image processing operation involves:
dividing the first master image into at least two areas; and
modifying at least one of the areas.

6. The method according to claim 5, wherein the image processing operation involves modifying each area on the basis of a different modification parameter.

7. The method according to claim 1, further comprising:
printing at least a pattern on the first printable substrate.

8. The method according to claim 1, further comprising:
printing a plurality of patterns on respective portions of the first printable substrate.

9. The method according to claim 8, wherein each pattern of the plurality is printed with a respective predetermined ink amount.

10. The method according to claim 7, wherein the pattern differs from the first master image.

11. The method according to claim 1, further comprising:
identifying a plurality of sectors on the surface of the first printable or printed substrate; and
measuring the deformation to obtain at least one deformation parameter for each of the sectors.

12. The method according to claim 1, wherein the predetermined operation is selected from the group comprising: heating, pressing, and/or laminating.

13. The method according to claim 1, wherein the printing is performed via inkjet printing.

14. The method according to claim 1, wherein the printing is performed via UV curable inks, water-based inks, or hydro-UV curable inks.

15. The method according to claim 1, wherein the first printable or printed substrate comprises an ink receiver layer and/or an adhesion promoter layer.

16. The method according to claim 1, wherein the second substrate is the same of the first substrate.

17. The method according to claim 1, wherein the second substrate comprises one or more features in common with the first substrate.

18. A method for manufacturing a panel, the method comprising:
providing a substrate;
attaching a decorative layer obtained from the method according to claim 1 on the substrate.

19. The method according to claim 18, wherein the decorative layer is subject to the predetermined operation.

20. A decorative layer for a decorative panel obtained from the method according to claim 1.
